(19) United States
(12) Patent Application Publication
(10) Pub. No.: US 2022/0023799 A1
(43) Pub. Date: Jan. 27, 2022

(54) MODULE FOR METERING A REDUCING AGENT, HAVING AN ELASTIC THERMAL BRIDGE

(71) Applicant: VITESCO TECHNOLOGIES GMBH, Hanover (DE)

(72) Inventor: Philippe MERTES, Toulouse (FR)

(21) Appl. No.: 17/294,077

(22) PCT Filed: Nov. 15, 2019
(86) PCT No.: PCT/EP2019/081432

§ 371 Date: May 14, 2021

(51) Int. Cl. B01D 53/94

(52) U.S. Cl. CPC B01D 53/9431; F01N 3/2066; B01D 53/9418

(57) ABSTRACT

A module for metering a reducing agent intended for a selective catalytic reduction post-treatment for a vehicle, this module including: a body in which the reducing agent circulates; a heating shell at least partially surrounding the body; at least one hydraulic connector in fluidic communication with the body; and an elastic thermal bridge between the heating shell and the hydraulic connector.

This application is the U.S. national phase of International Application No. PCT/EP2019/081432 filed Nov. 15, 2019 which designated the U.S. and claims priority to FR Patent Application No. 1860548 filed Nov. 15, 2018, the entire contents of each of which are hereby incorporated by reference.

### BACKGROUND OF THE INVENTION

### Field of the Invention

The invention concerns the field of automotive engineering and relates to a module for metering a reducing agent intended for a Selective Catalytic Reduction (SCR) post-treatment for a vehicle.

### Description of the Related Art

Patent application US2008/0236147 describes a unit for distributing a reducing agent intended for selective catalytic reduction post-treatment for a vehicle. Such a unit, generally referred to as a “reducing agent injector”, is mounted on a catalytic exhaust device in order to inject the reducing agent into same.

Selective catalytic reduction post-treatment has become unavoidable for certain vehicles given the changes to the legislation on reducing emissions, particularly nitrogen oxide (NOx) emissions. The reducing agent is generally a solution based on urea, such as AUS 32. The aforementioned patent application sets out the problems associated with extreme temperatures with regard to reducing agents. Specifically, AUS 32, for example, freezes at around −8° to −10°, whereas automotive specifications generally require the vehicle to operate down to −40°. There are various solutions already implemented for heating the reducing agents at the low temperatures and thus allowing the selective catalytic reduction post-treatment device to operate at temperatures below −8°. The aforementioned patent application sets out solutions targeting the reducing agent injector.

A complete selective catalytic reduction post-treatment device comprises, in addition to the reducing agent injector, a reducing agent tank and a reducing agent metering module. The reducing agent tank stores the reducing agent and is periodically filled by the user. The metering module is generally connected to this tank by flexible pipes and comprises a pump so that the reducing agent can be distributed to the injector, likewise via flexible pipes.

At the present time, developments in pollution-control legislation are tending not only to make selective catalytic reduction post-treatment unavoidable for certain vehicles, but are also demanding that this treatment be implemented in the very first seconds after the starting of the engine of the vehicle. Thus, when the exterior temperature is below the freezing point of the reducing agent and the vehicle is then started, the metering module needs to be capable of very quickly thawing the reducing agent it contains so that the post-treatment device can come into operation as early as possible. The heating solutions within the reducing agent metering module are generally supplemented by flexes, themselves heating, and by solutions for heating the injectors, such as the solutions described in the aforementioned patent application.

The devices of the prior art, and particularly the reducing agent metering modules, need to be continuously improved in order to maintain compliance with the changes in the legislation.

### SUMMARY OF THE INVENTION

The aim of the invention is to improve the reducing agent distribution modules of the prior art.

To this end, the invention relates to a module for metering a reducing agent intended for a selective catalytic reduction post-treatment for a vehicle, this module comprising:
a body in which the reducing agent circulates;
a heating shell at least partially surrounding the body;
at least one hydraulic connector in fluidic communication with the body;
an elastic thermal bridge between the heating shell and the hydraulic connector, holding the hydraulic connector in place relative to the body.

In such a metering module, the heating that allows the thawing of all of the reducing agent present in the module is more rapid than in a module of the prior art. The time required for the post-treatment to come into operation is therefore shortened in the event of an engine start at a temperature at which the reducing agent is frozen.

In such a metering module, uniform diffusion of the temperature performed right to the ends consisting of the hydraulic connectors allows connection of the module to the rest of the system. Such uniformity of the heating of the reducing agent makes it possible to supplement the diffusion of the heat that travels by conduction within the reducing agent.

This progress in the speed at which the reducing agent is heated up can, incidentally, be converted fully or in part into a reduction in the thermal power needed for heating up the reducing agent.

Furthermore, the metering module is able to manage the stresses associated with the increase in volume of the reducing agent as it freezes. Specifically, just like water of which it is partially made up, the reducing agent generally increases in volume when it enters the solid phase. AUS 32, for example, exhibits an around 8% increase in volume as it freezes. This increase in volume places a great deal of stress on the metering modules, the castings of which may crack, and therefore requires that expensive and complex solutions be set in place, such as fitting compressible plugs in the ducting. The metering module according to the invention allows this increase in volume to be managed using means that are simple and inexpensive.

The reducing agent metering module may also comprise the following additional features, alone or in combination:
the hydraulic connector comprises a heat-conduction flange in contact with the elastic thermal bridge;
the heat-conduction flange has a thermal conductivity of at least 3 Watts per meter Kelvin;
the heat-conduction flange is produced in an insert of the hydraulic connector;
the hydraulic connector comprises a tube overmolded on the insert;
the body and the hydraulic connector are fluidically connected by a slideway connection;
the slideway connection is achieved by a male cylinder inserted inside a female cylinder, one of these cylinders being on the body and the other of these cylinders being on the hydraulic connector;
the slideway connection comprises a sliding seal;
the module comprises a stop flange and a stop shoulder, one produced in the hydraulic connector and the other produced in the body, the elastic thermal bridge urging the stop flange and the stop shoulder against one another;
the stop flange is on the hydraulic connector and the stop shoulder is on the body, the stop flange being juxtaposed with respect to the heat-conduction flange;
the body comprises a boss for the fixing of the hydraulic connector, and the heating shell comprises a sleeve at least partially surrounding this boss;
the heating shell has a heat exchange flat surface against which there bears a flat bearing upstand of the elastic thermal bridge;
the elastic thermal bridge comprises an elastic metal clip;
the elastic thermal bridge comprises at least one elastic tab extending substantially perpendicular to the longitudinal axis of the hydraulic connector, this elastic tab bearing against the hydraulic connector;
the elastic thermal bridge comprises two curved elastic tabs extending on either side of a cutout surrounding the hydraulic connector.

### BRIEF DESCRIPTION OF THE DRAWINGS

Further features and advantages of the invention will become apparent from the description that is given hereinafter by way of non-limiting example, with reference to the accompanying drawings, in which:

FIG. 1 is a perspective overview of a reducing agent metering module according to the invention;

FIG. 2 is a detailed view in cross section of the module of FIG. 1 at a hydraulic connector;

FIG. 3 is a view in cross section perpendicular to the cross section of FIG. 2;

FIG. 4 is a perspective depiction of the elastic thermal the bridge of the module of FIG. 1;

FIG. 5 is a view of the elastic thermal bridge of FIG. 4, in another view.

### DESCRIPTION OF THE PREFERRED EMBODIMENTS

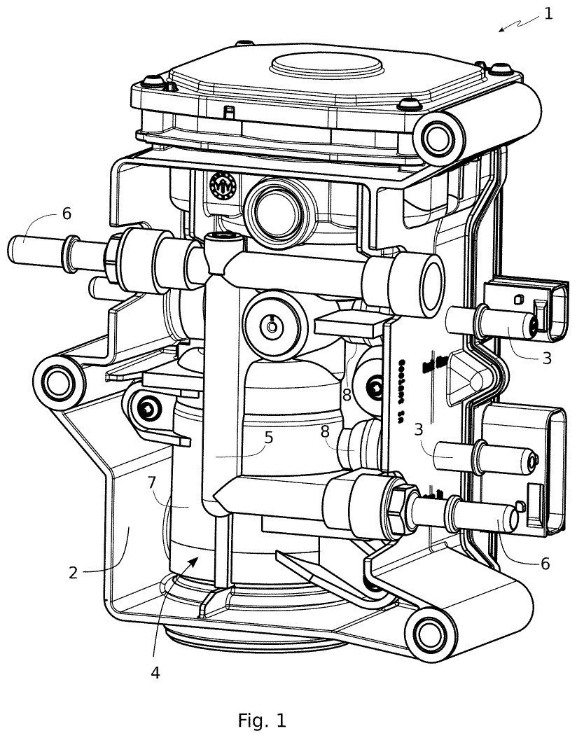

FIG. 1 depicts a module 1 for distributing a reducing agent intended for a selective catalytic reduction post-treatment. This module 1 is intended to be mounted in a vehicle and to be connected, on the one hand, to a reducing agent tank and, on the other hand, to a reducing agent injector mounted on the catalytic exhaust device.

The module 1 comprises a body 2 which, in the present example, is a molded component forming the exterior case of the module 1, as well as the internal circulation pipes for the reducing agent and any tanks in which the reducing agent may be present as it circulates within the module 1. For reasons concerned with reducing production costs, something which is essential in the automotive field, the body 2 is made as a single piece from polymer obtained by molding. This polymer therefore needs to be able to resist the reducing agent which, in general, is corrosive. Polymers known for their ability to resist reducing agents have low thermal conductivities.

The module 1 comprises two hydraulic connectors 3 connected to the body 2. The hydraulic connectors 3 in the example illustrated allow the module 1 to be connected respectively to a reducing agent tank and to a reducing agent injector. The hydraulic connection between the connectors 3 and the components external to the module 1 is achieved using heating fluids (not depicted).

The module 1 performs the conventional functions of a metering module and comprises filtering members, sensors such as pressure sensors, and a pump for distributing to the injector the reducing agent that comes from the tank. These conventional functionalities of the metering module 1 are known and will not be described in further detail here.

The module 1 comprises a heating shell 4 fixed to the body 2 and partially surrounding the body 2. The heating shell is made of metal (or made of some other material with a high thermal conductivity) and is notably arranged around those portions of the body 2 in which the reducing agent is circulating.

The heating shell 4 is, in the present example, heated by the circulation of the engine coolant. The engine coolant circulates in the heating shell 4 to supply it with the heat energy needed for it to perform its action of heating the reducing agent. In FIG. 1, the heating shell 4 is molded as a single piece, with engine coolant circulation ducts 5. The heating shell 4 also comprises, in addition, three hydraulic connectors 6 connected to these ducts 5. These hydraulic connectors 6 are therefore connected via pipes to the rest of the vehicle cooling circuit.

In a variant, the heating shell 4 may be heated by any other means such as by the circulation of a hot fluid other than the fluid coming from the engine, or by direct heating supplied by electrical heating means incorporated into the heating shell 4.

Whatever the way in which the heating shell 4 is heated, it diffuses its heat towards the reducing agent, by enveloping the module 1 at the appropriate points. For example, in FIG. 1, a portion 7 of the shell 4 has a cylindrical shape surrounding a cylindrical filter full of reducing agent situated inside the body 2.

As far as hydraulic connectors 3 are concerned, the heating shell 4 surrounds the base of the connectors 3 via an extension of the shell 4 in the form of the sleeve 8.

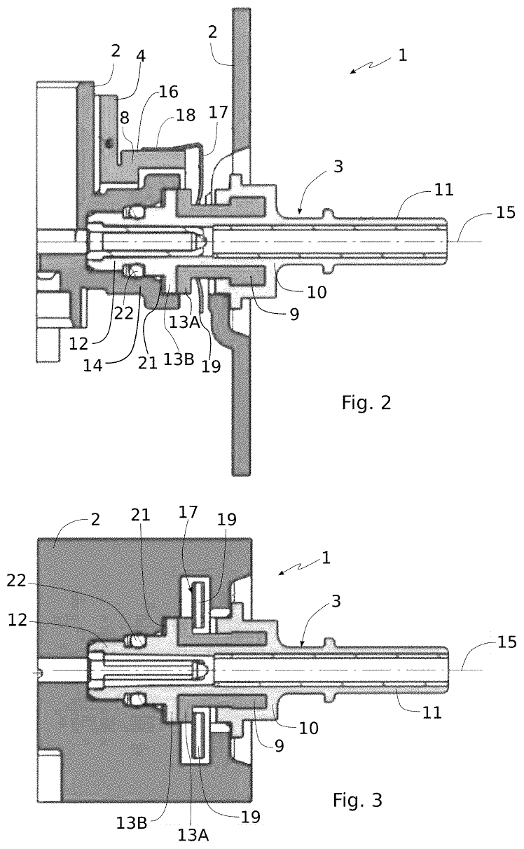

FIG. 2 is a view in section on a plane passing through the longitudinal axis of a hydraulic connector 3, the plane of section being horizontal (with reference to FIG. 1). This figure shows the collaboration between the hydraulic connector 3, the body 2 and the heating shell 4.

The hydraulic connector 3 is made up of two distinct coaxial portions: an insert 9 having good thermal conductivity, such as a metal, or a polymer adapted to the conduction of heat. A tube 10 is overmolded onto this insert 9 to constitute the hydraulic connector 3. The overmolded tube 10 is chosen to be made of a material resistant to the corrosive properties of the reducing agent, these materials not being very good conductors of heat. The insert 9 thus improves the overall thermal conductivity of the connector 3 for diffusing heat into the central zone of the hydraulic connector 3.

One particularly advantageous embodiment for the hydraulic connector 3 is a molding of an insert 9 made of a polymer having a good enough thermal conductivity for this application, in the order of at least 3 Watts per meter Kelvin (W m⁻¹ K⁻¹), and by an overmolding of the tube 10 onto this insert. These two operations can thus both be performed, quickly and at low cost, in a conventional injection-molding machine used for polymer.

The hydraulic connector 3 comprises, at one of its ends, a connector portion 11 allowing connection of a heating flex, and comprises, at its other end, a portion 12 for connection to the body 2. The portion 12 for connection to the body 2 is equipped with a stop flange 13. This flange 13 consists of the juxtaposition:
of a heat-conduction flange 13A, formed on the insert 9;
of a stop flange 13B, formed on the insert 9.

The body 2 comprises, at its junction with the connector 3, a boss 14 in fluidic communication with those portions of the body 2 in which the reducing agent circulates. The portion 11 of the connector 3 is pushed into the boss 14. The internal surface of the boss 14 and the external surface of the portion complement one another and allow this push-fit. The connection thus formed between the boss 14 of the body 2 and the portion 11 of the connector 3 is a slideway connection of which the axis is the longitudinal axis 15 of the connector 3. The connector 3 can effectively move translationally along this axis 15 with respect to the boss 14. This slideway connection is therefore achieved here by inserting a male cylinder (the portion 11 of the connector 3) into a female cylinder (the boss 14).

An O-ring 22 also seals the assembly between the connector 3 and the boss 14. The O-ring 22 is able to slide, which means to say that it maintains this sealing as the connector 3 moves in translation relative to the boss 14.

The sleeve 8 of the heating shell 4 at least partially surrounds the boss 14, which means that the axial end of the boss 14 and the axial end of the sleeve 8 are close to one another. The sleeve 8 also has a flat surface 16 at this axial end.

The connector 3 is held in place relative to the body 2 by an elastic thermal bridge 17 which, in the present example, consists of a metal clip in the shape of a fork.

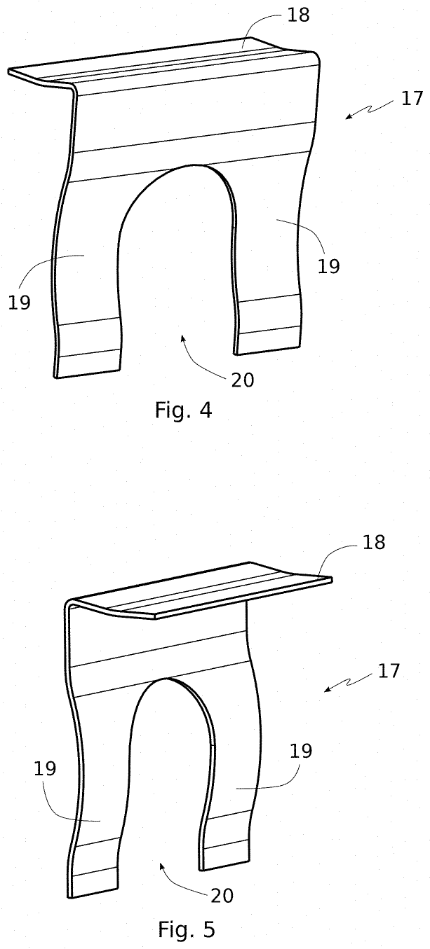

FIG. 3 is a view of FIG. 2 from beneath, detailing the shape of the thermal bridge 17 from this viewpoint. The thermal bridge 17 is also depicted in perspective, in two views, in FIGS. 4 and 5.

The thermal bridge 17 comprises an upstand 18 for bearing against the heating shell 4. The bearing upstand 18 provides planar contact between the thermal bridge 17 and the flat surface 16 of the sleeve 8, favoring the transmission of heat. The thermal bridge 17 comprises two elastic tabs 19, extending substantially perpendicular to the bearing upstand 18, on either side of a cutout 20. The elastic tabs 19 are curved and bear against the heat-conduction flange 13A of the connector 3. The thermal bridge 17 thus urges the connector 3 against the body 2. This urging causes the stop flange 13B to be pressed firmly against a stop shoulder 21 of the boss 14.

The configuration of FIGS. 2 and 3 corresponds to a situation in which the reducing agent is in the liquid state. When the vehicle is not in use and the temperature is sufficiently low, the reducing agent freezes inside the body 2 and inside the connector 3.

The increase in the volume of the reducing agent as a result of it freezing causes the connector 3 to slide with respect to the boss 14 along the slideway connection. The thermal bridge 17 accompanies the movement of the connector 3 away from the boss 14 by deforming elastically. The bearing upstand 18 remains in position on the flat surface 16 while the elastic tabs 19 elastically deform. The further the connector 3 moves away from the boss 14, the greater the stress of the elastic tabs 19 on the heat-conduction flange 13A.

Thus, when the vehicle is brought into operation while the reducing agent in the module 1 is frozen, the heating shell 4 increases in temperature and its heat is transmitted via the thermal bridge 17 between the sleeve 8 and the insert 9 which then diffuses the heat within the connector 3 towards the reducing agent. Heat is therefore rapidly diffused toward this central zone of the reducing agent which is situated between the connector portion 11 (heated by the heating flex) and the connection portion 12 (heated by the sleeve 8). This central zone of the reducing agent, without the intervention of the thermal bridge 17, would have available to it only the conduction of heat within the reducing agent in order to heat it. The greater the pressure of the elastic tabs 19 on the insert 9 as a result of the elastic deformation of said tabs, the more efficient the work of the thermal bridge 17. In other words, the freezing situation that entails rapid heating is precisely the situation the conditions of which favor this heating by elastically deforming the thermal bridge 17.

When the reducing agent returns to its liquid state, the pressure of the elastic tabs 19 gradually returns the connector 3 against the boss 14 until a condition of abutment and the configuration of FIGS. 2 and 3 is reached.

Variant embodiments of the module may be envisioned without departing from the scope of the invention. For example, the thermal bridge may be produced in any material providing good conduction of heat and its shape may include any kind of spring element allowing it to perform its elastic function.

1. A module (1) for metering a reducing agent intended for a selective catalytic reduction post-treatment for a vehicle, this module comprising:
a body (2) in which the reducing agent circulates;
a heating shell (4) at least partially surrounding the body (2);
at least one hydraulic connector (3) in fluidic communication with the body (2);
the module comprising an elastic thermal bridge (17) between the heating shell (4) and the hydraulic connector (3), holding the hydraulic connector (3) in place relative to the body (2).

2. The module as claimed in claim 1, wherein the hydraulic connector (3) comprises a heat-conduction flange (13A) in contact with the elastic thermal bridge.

3. The module as claimed in claim 2, wherein the heat-conduction flange (13A) has a thermal conductivity of at least 3 Watts per meter Kelvin.

4. The module as claimed in claim 2, wherein the heat-conduction flange (13A) is produced in an insert (9) of the hydraulic connector (3).

5. The module as claimed in claim 4, wherein the hydraulic connector (3) comprises a tube (10) overmolded on the insert (9).

6. The module as claimed in claim 1, wherein the body (2) and the hydraulic connector (3) are fluidically connected by a slideway connection.

7. The module as claimed in claim 6, wherein the slideway connection is achieved by a male cylinder (12) inserted inside a female cylinder (14), one of these cylinders being on the body (2) and the other of these cylinders being on the hydraulic connector (3).

8. The module as claimed in claim 7, wherein the slideway connection comprises a sliding seal (22).

9. The module as claimed in claim 2, further comprising a stop flange (13B) and a stop shoulder (21), one produced in the hydraulic connector (3) and the other produced in the body (2), the elastic thermal bridge (17) urging the stop flange (13B) and the stop shoulder (21) against one another.

10. The module as claimed in claim 9, wherein the stop flange (13B) is on the hydraulic connector (3) and the stop shoulder (21) is on the body (2), the stop flange (13B) being juxtaposed with respect to the heat-conduction flange (13A).

11. The module as claimed in claim 1, wherein the body (2) comprises a boss (14) for the fixing of the hydraulic connector (3), and wherein the heating shell (4) comprises a sleeve (8) at least partially surrounding this boss (14).

12. The module as claimed in claim 1, wherein the heating shell (4) has a heat exchange flat surface (16) against which there bears a flat bearing upstand (18) of the elastic thermal bridge (17).

13. The module as claimed in claim 1, wherein the elastic thermal bridge (17) comprises an elastic metal clip.

14. The module as claimed in claim 1, wherein the elastic thermal bridge (17) comprises at least one elastic tab (19) extending substantially perpendicular to the longitudinal axis (15) of the hydraulic connector (3), this elastic tab (19) bearing against the hydraulic connector (3).

15. The module as claimed in claim 14, wherein the elastic thermal bridge (17) comprises two curved elastic tabs (19) extending on either side of a cutout (20) surrounding the hydraulic connector (3).

16. The module as claimed in claim 3, wherein the heat-conduction flange (13A) is produced in an insert (9) of the hydraulic connector (3).

17. The module as claimed in claim 2, wherein the body (2) and the hydraulic connector (3) are fluidically connected by a slideway connection.

18. The module as claimed in claim 3, wherein the body (2) and the hydraulic connector (3) are fluidically connected by a slideway connection.

19. The module as claimed in claim 4, wherein the body (2) and the hydraulic connector (3) are fluidically connected by a slideway connection.

20. The module as claimed in claim 5, wherein the body (2) and the hydraulic connector (3) are fluidically connected by a slideway connection.
